(19) United States
(12) Patent Application Publication
(10) Pub. No.: US 2007/0038949 A1
(43) Pub. Date: Feb. 15, 2007

(54) Copyholder graphical user interface

(76) Inventors: Leslie Chan, San Francisco, CA (US); Tana Jackson, Sunnyvale, CA (US); Dan Weller, Palo Alto, CA (US)

Correspondence Address: HELLER EHRMAN LLP, 275 MIDDLEFIELD ROAD, MENLO PARK, CA, 94025-3506, US

(21) Appl. No.: 11/444,967

(22) Filed: May 31, 2006

Related U.S. Application Data
(60) Provisional application No. 60/686,508, filed on May 31, 2005.

(51) Int. Cl. G06F 17/00

(52) U.S. Cl. 715/767; 715/769

(57) ABSTRACT

A user interface is provided that enables a user to view, navigate and perform actions on an online document. The user interface is represented as a sliding window which appears to move smoothly across the document text. The sliding window, from herein referred to as the copyholder, moves across the document to locations in the document text that are defined by the underlying document. The copyholder size is determined by the underlying document, it can expand the width of the document text and the length of an active section or it can appear as a clip attached to the edge of the document. The copyholder contains an action bar with icons representing actions that can be performed on the document text. The current location of the copyholder in a document is saved when the document is closed. The copyholder will move to the saved location in the document text when the document is resumed and display the copyholder around the active document text.

### RELATED APPLICATIONS

This application claims the benefit of 60/686,508, filed May 31, 2005, which application is fully incorporated herein by reference.

### BACKGROUND

1. Field of the Invention

The present invention relates generally to a graphical user interface that assists a user in viewing, navigating and using online documents, and more particularly to a graphical user interface that is represented as an online line guide or copyholder, a graphical frame displayed around the active text of the document.

2. Description of the Related Art

The continued growth of online documentation and applications for performing daily tasks has led to the need for an easier user interface for navigating and using these documents. In today's environment, people are less likely to use hard copies of documents to get their work done; documents are primarily available to users online. By way of example, and without limitation, in the area of procedure management, company procedures and processes which define the set of steps or instructions that must be followed to accomplish a task may be available to users online. The ability for a user to see what step of the procedure they are working on, to take action on a step of a procedure and to have the last step worked on recalled when a procedure document is suspended and reopened would be of great benefit to the user. Users need a better way to navigate and use online documents.

There is a need for a user interface that guides a user through use of online documents. There is a need for a visual representation of a users' current location in a document. If a user closes a document that they are working on, there is a need to reopen the document at this last location worked on.

### SUMMARY OF THE INVENTION

Accordingly, an object of the present invention is to provide an improved graphical user interface.

Another object of the present invention is to provide a graphical user interface that guides a user through the use of online documents.

Yet another object of the present invention is to provide a graphical user interface that provides a visual representation of a users' current location in a document.

A further object of the present invention is to provide a graphical user interface that enable a user to close a document it is working on and then reopen the document at this last location worked on.

These and other objects of the present invention are achieved in, a user interface for viewing, navigating and using online procedure documents. Each procedure document has a set of well defined steps that define procedure content. A copyholder is provided that is a sliding window. The copyholder surrounds a step in the procedure document. The step enclosed by the copyholder is an active step. A representation of the copyholder is a line guide that slides across document text and guides a user through the set of steps of the document. A toolbar is provided on the copyholder. The toolbar has toolbar icons that represent actions to be performed on the active step of the document. An auto advance feature of the copyholder advances the copyholder to a subsequent next step in the document. At least one navigation icon on the copyholder enables the user to drag and drop the copyholder to any step defined in the document.

In another embodiment of the present invention, a user interface for viewing and navigating an online document that includes sections has a copyholder that is a sliding window. The copyholder surrounds a section of the document. The surrounded section is an active section. A representation of the copyholder is a line guide that slides across text of the online document and guides a user through the sections of the online document. The copyholder includes an auto advance that provides advancement to a next section in the document. The copyholder has navigation icons that permit the user to drag and drop the copyholder to any section in the document. A toolbar on the copyholder has toolbar icons that represent actions to be performed on the active section of the document.

In another embodiment of the present invention, a method is provided for navigating and using online procedure documents that include a set of well defined steps which define procedure content of a procedure document. A copyholder that is a sliding window is used to surround a step in the procedure document. A representation of the copyholder is sued as a line guide to slide across text of the procedure document and guide a user through the set of steps of the procedure document. A toolbar on the copyholder is used that includes toolbar icons representing actions to be performed on the active step of the procedure document. The copyholder is advanced to a subsequent next step in the procedure document. At least one navigation icon is sued on the copyholder to drag and drop the copyholder to any step defined in the procedure document.

### BRIEF DESCRIPTION OF THE DRAWINGS

FIG. 1 is one representation of a copyholder interface.

FIG. 2 is a representation of a copyholder interface with navigation capability.

FIG. 3 is another representation of a copyholder with navigation displayed as a handle on the copyholder.

FIG. 4 is a representation of a copyholder interface with actions on the toolbar.

FIG. 5 is one representation of an opaque copyholder.

FIG. 6 is a representation of a collapsed copyholder. Navigation and action capabilities are provided.

FIG. 7 displays an expanded copyholder; the length of the copyholder is calculated based on the size of the active step in a document.

FIG. 8 is a representation of a docked view of the copyholder.

FIG. 9 is a representation of a docked view of a copyholder with action and navigation capability.

FIG. 10 is a representation of a copyholder with the ability to switch to a docked view.

FIG. 11 is a representation of a copyholder with step actions.

FIG. 12 displays the auto advance capability of a copyholder once a step is marked as completed.

### DETAILED DESCRIPTION

In one embodiment of the present invention, a graphical user interface is provided that guides a user through the use of online documents. In one embodiment, if a user closes a document that it is working on, the graphical user interface permits a reopening of the document at this last location worked on. A line guide that highlights the users' current location in a document; remembers this location if the document is closed and enables document specific actions to be performed on the text at this location is needed. In one embodiment, the present invention defines a user interface that enables users to use online documents and permits the user to be interactively guided through using these documents and enables the user to suspend its work knowing that the line guide will remember where the user left off when the user reopens its document.

In one specific embodiment, the graphical user interface of the present invention is utilized in the area of procedure management. Each procedure is defined to contain a set of steps needed to accomplish the procedure or process in a system.

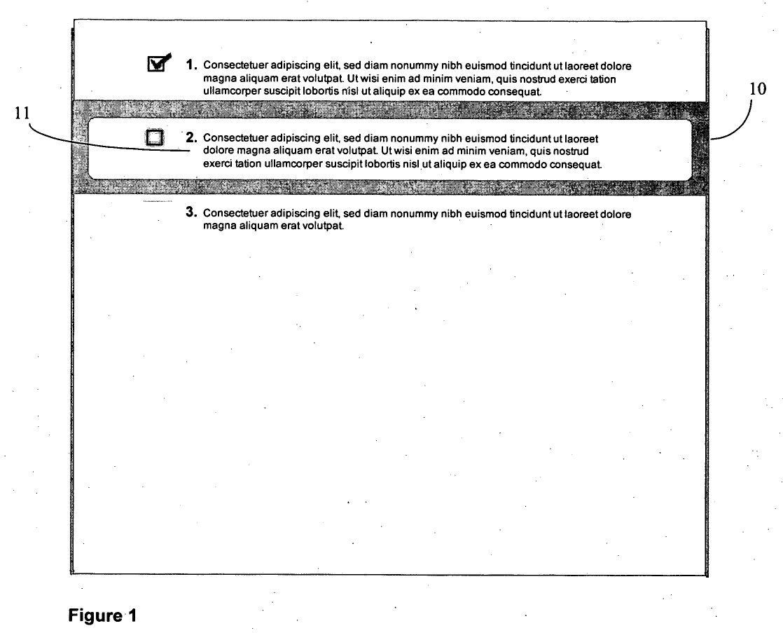

In one embodiment of the present invention, a graphical interface is defined that assists a user in viewing, navigating and using a procedure management document. By way of illustration, and referring now to FIG. 1, an example of this interface is displayed. The copyholder interface 10 appears as a sliding window on top of the document text. By way of example, and without limitation, the document text 11 can be plain or structured text. The text 11 that is within the frame of the copyholder is considered the active text. The copyholder looks like a framed window 10 that appears to slide on top of the document text. By way of example, and without limitation, the copyholder extends the width of the document page and seems like a line guide attached to the edge of the document. The copyholder tracks the current active location as it moves through the document. The underlying document will define the text 11 that displays inside the copyholder. Referring again to FIG.1, a step of the procedure document is highlighted by the copyholder and the text of the step is the active text.

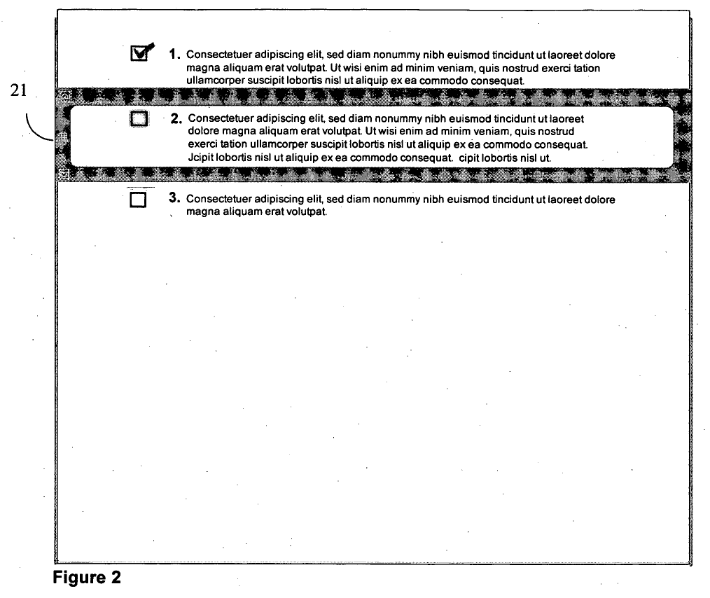

In another embodiment of the invention, the user interface of the copyholder is expanded to include a navigation capability. The copyholder can be moved around the document text. The copyholder is expanded to include a navigation ability to slide the copyholder across the document. By way of example, and without limitation, the navigation can be represented as navigation icons on the copyholder or as a navigation bar on the navigation window that appears to clip the copyholder to the document text. The copyholder looks as if it slides over the document text once navigation is selected and can be viewed as a line guide moving through the document. The underlying document page will implement the next and previous navigation points, the copyholder will move to the specific location in the document as defined for previous and next points. Referring now to FIG. 2, by way of illustration and without limitation, scroll icons 21 have been added to the copyholder. In this specific example, each step of the illustrated document is considered a navigation point and the navigable window will be moved to the next or previous step each time the scroll up or down arrows are selected. The text inside the copyholder is the active text, while the rest of the document text is visible to the user of the document. By way of another example, and without limitation, navigation can also be achieved by selecting the copyholder and dragging it to a new location in the document. The copyholder will slide across the document and anchor to the closest navigation point once released. Referring again to FIG. 2, by way of illustration, each step in the document is considered a navigation point. The navigable window will be moved to the step closest to where the copyholder was dropped.

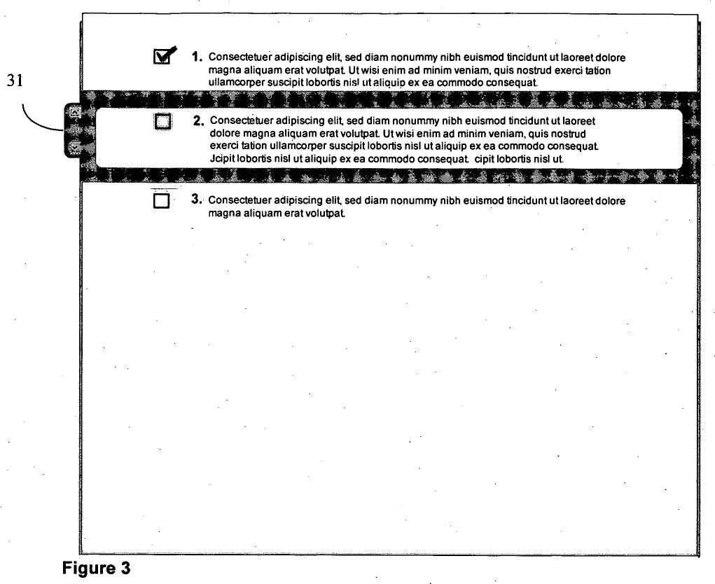

Referring to FIG. 3, another example of how the navigation can be represented on the copyholder is shown. In this example, the navigation bar looks like a handle or clip 31 on the copyholder. The user can drag this handle to a new location in the document, or select the navigation arrows on the handle to move the copyholder to the next navigation point as defined by the underlying document page. The copyholder will appear to slide over the document text to its new location.

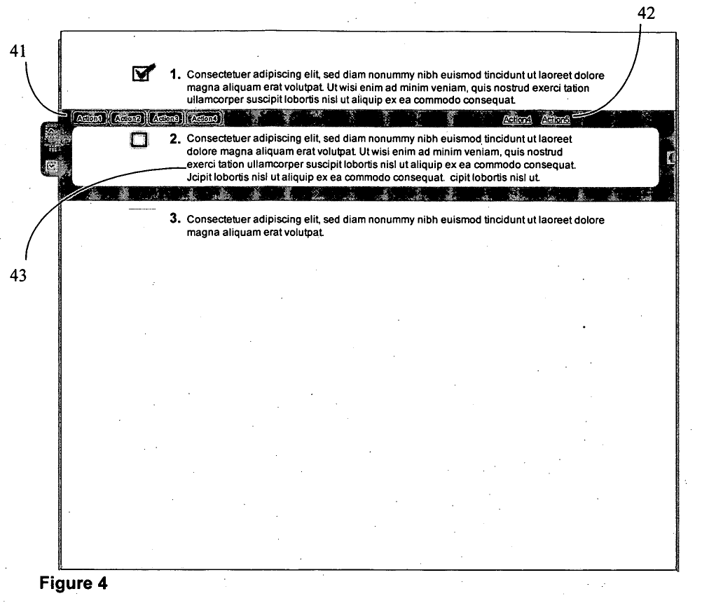

In another embodiment of the present invention, the sliding navigable copyholder is expanded to include a toolbar. The toolbar defines a set of actions to be performed on the text within the copyholder. By way of illustration, in this example the navigable window can select the text of a single step in a document. The toolbar will define the actions that can be performed on the active step. By way of example, and without limitation, action1 could be to mark the step as read or to add a note to the step. Referring now to FIG. 4, the navigable window has been expanded to include a set of toolbar actions 41. By way of example, and without limitation, the toolbar actions can be displayed as buttons 41 or links 42. The actions defined in each of these action buttons 41 or links 42 will be performed on the text 43 that is displayed within the sliding navigable copyholder. The toolbar actions defined will be related to the underlying document text.

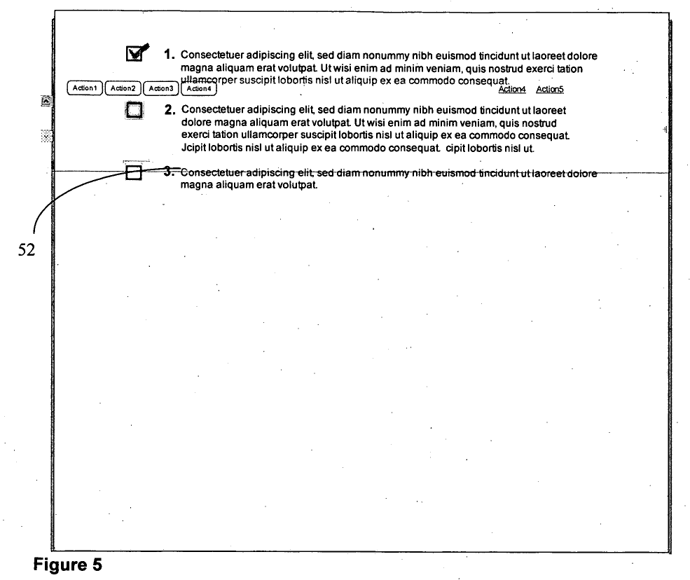

In each embodiment of the current invention, the copyholder is displayed as a frame that seems to slide on top of the document text. The copyholder can be represented to have either a solid or transparent border on the window frame. By way of example, and without limitation, if the border is defined as transparent any text that appears to be under the frame would be visible to the user. Referring now to FIG. 5, an example of what a transparent copyholder would look like is displayed. In this specific example, the text of the first sentence in step 3 is visible through the frame 52. By way of illustration, the frame of the copyholder is equivalent to a clear line guide that moves across the document.

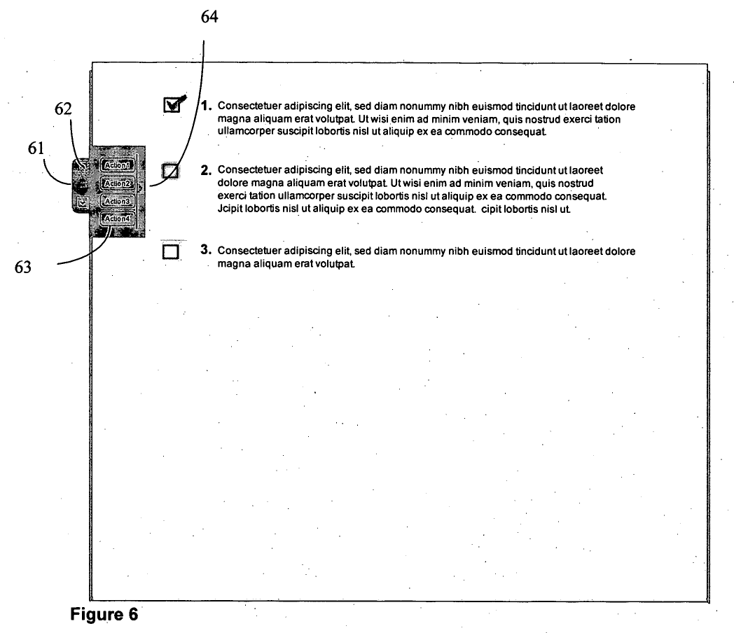

In another embodiment of the current invention, the ability to collapse the copyholder is defined. The copyholder that surrounds the active text can be collapsed and displayed as a copyholder clip with the embedded toolbar actions. The collapsed copyholder looks as if it is attached to the edge of the document page. The slider clip will appear to slide up and down the edge of the document opposite the active text. Referring now to FIG. 6, an example of a collapsed copyholder is displayed 61. The ability to navigate the window to the previous or next navigation point 62 in the document and to select actions to be performed 63 on the active step is available. In this example, the window frame that surrounded the active text has been removed. The ability to expand the copyholder 64 and collapse it down, are provided. By way of example, and without limitation, this can be achieved by adding an icon to the copyholder toolbar to collapse or expand copyholder 64. Referring again to FIG. 6, in this example the collapsed copyholder has a right arrow icon that will expand the copyholder to full size 64.

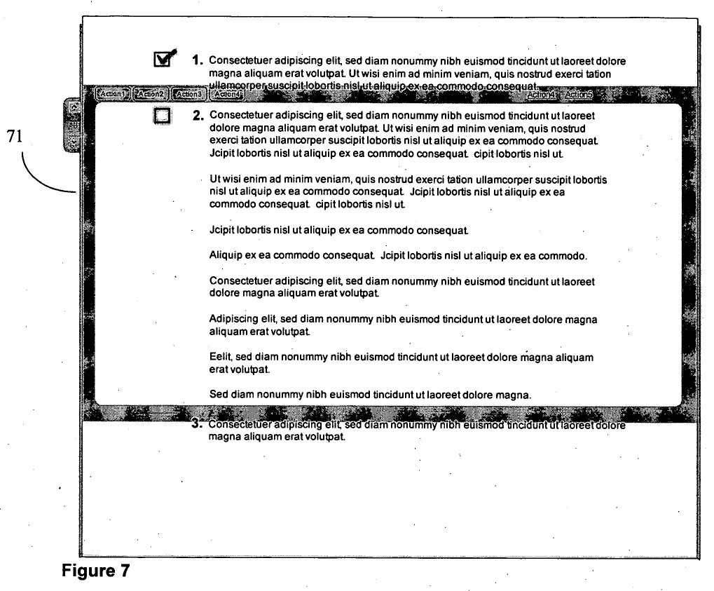

In each embodiment of the current invention, the navigable sliding window will resize to enable the text of the current step to be viewed. By way of example, and without limitation, the step is defined by the underlying document text and could be a step within a document or a paragraph within a document. The underlying document will determine the height of the next component to be selected as active text and the copyholder will resize to enable display of this component. Referring now to FIG. 7, an example of a larger active step is displayed 71. By way of illustration, in this specific example, the height of the copyholder is calculated to enable the text of this step to display within the copyholder 71.

In yet another embodiment of the invention, the copyholder is presented to the user in a workspace that is isolated from the user's desktop. In this embodiment, the copyholder will appear as a fixed window on the user's screen, and the text of the document will appear to scroll through the fixed copyholder. By way of illustration, this can be viewed as equivalent to a user pulling a document through a document holder. By way of example, and without limitation, a portion of the user's screen can be reserved to display the copyholder and make it appear to the user that it is docked here. The user can define where on their desktop they want to dock the window. By way of example, and without limitation, this could be the top, bottom or side of their screen. In this embodiment, a workspace is created on the user's screen that is isolated from the rest of the user's desktop. The workspace remains visible on the user's screen to provide for the user to see the location in the document that is currently active. The text that is within the docked copyholder is the active text; no other text of the document is visible on the user's screen. In this embodiment of the invention, the docked copyholder is defined as a fixed size. The underlying document will scroll through this fixed copyholder when the navigation arrows on the window are selected. The amount of text that scrolls is dependent on the underlying document and how the next and previous navigation points are defined.

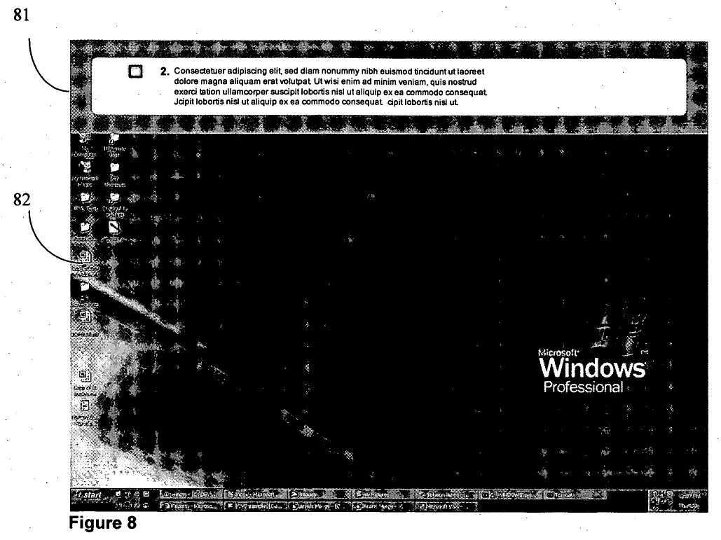

Referring now to FIG. 8, an example of a docked view of the copyholder is displayed. The copyholder appears docked at the top of the user's desktop 81—the rest of the desktop 82 is available to the user to run other applications. The copyholder will not be overwritten with data from any other applications and will appear always at the location defined on the user's screen for the docked copyholder view.

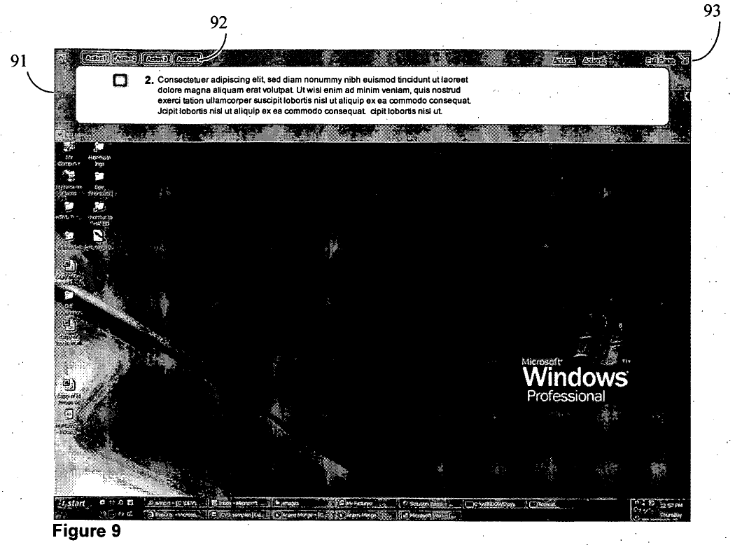

In another embodiment of the current invention, the ability to expand the docked copyholder to include a toolbar of actions is defined. Similar to what was defined with the sliding copyholder, this toolbar can define actions to be performed on the text within the window. As illustrated in FIG. 9, the docked window toolbar defines a set of actions 92 that can be applied to the text in the docked copyholder. By way of example, and without limitation, this could be the ability to mark the outcome of the active step or to add comments to the step.

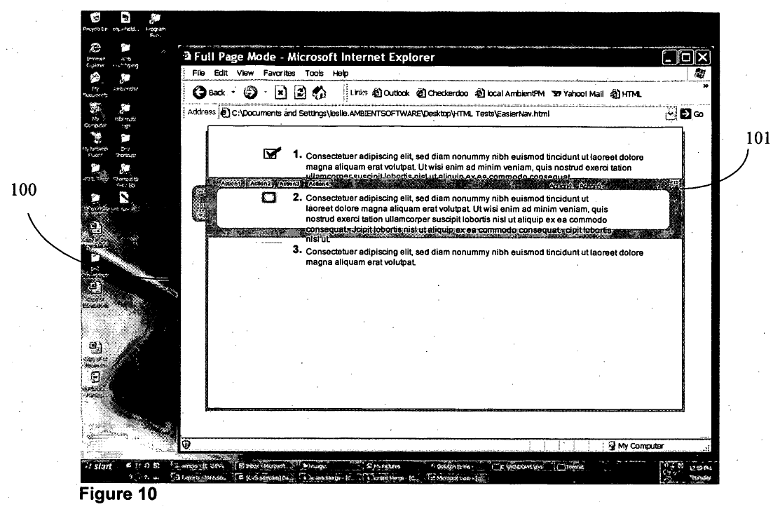

In another embodiment of the current invention, the ability to switch between the sliding copyholder and the docked copyholder is defined. By way of example, this can be achieved by a link on the sliding copyholder which will switch to a docked view, and conversely by a link on the docked view which will switch back to the sliding navigable view. Users can determine which copyholder user interface works best for viewing and navigating through their document. They can switch between the two modes by selecting the appropriate link on the copyholder. Referring again to FIG. 9, an example of what the docked view 91 with a link 93 to the sliding navigable window may look like is displayed. By way of illustration, and without limitation, a link to switch to a full page view is added to the toolbar 93. By selecting this link or the arrow displayed next to it, the user's copyholder view will switch from docked mode back to the full mode display of the sliding copyholder. Referring now to FIG. 10, an example of the full mode display of the sliding copyholder is shown 100. By way of illustration, and without limitation, this example shows an arrow on the toolbar 101 that will switch the user back to the docked mode.

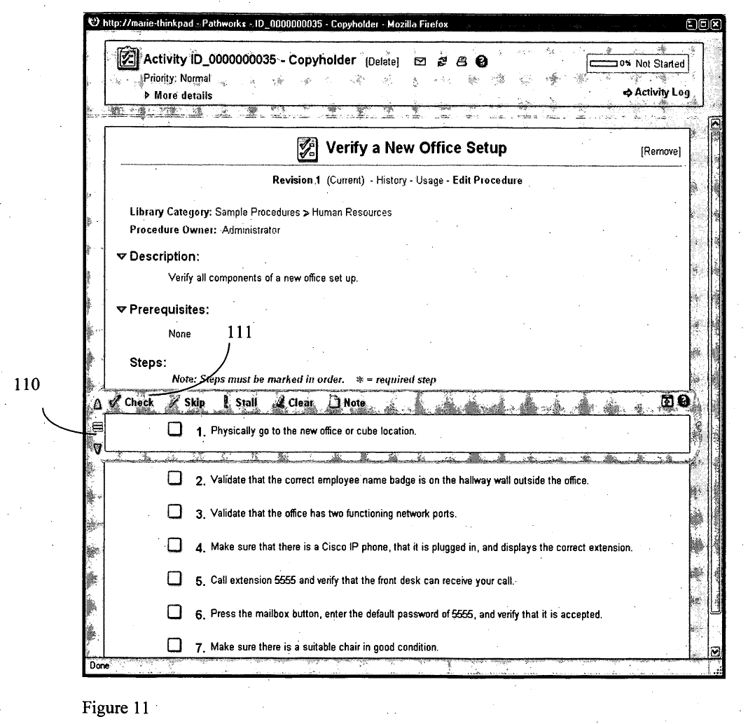

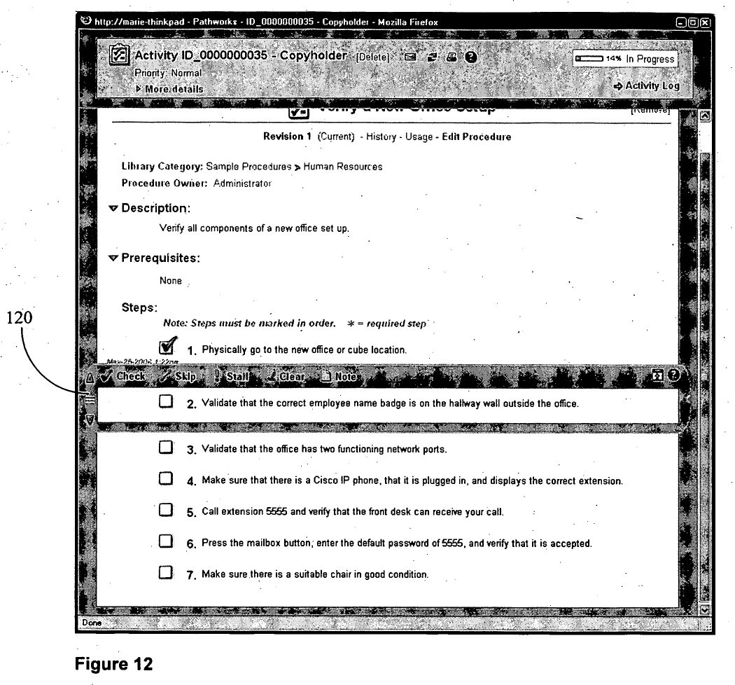

As indicated previously, the copyholder will advance through each navigation stop within a document. By way of illustration, in a procedure management document each step would be considered a navigation stop. The copyholder will initially display at the first step of a document when it is initially opened. The first step will be determined by the underlying document text. By way of example, and referring now to FIG. 11, in a procedure document this would be the first step of the procedure 110. The copyholder will automatically advance to the next step in a document if a step completion action is selected from the action toolbar. By way of example, this could be to mark the step as completed 111, skipped 111 or stalled 111. Referring now to FIG.12, the copyholder has advanced to the next step in the procedure document 120. The underlying system will implement methods to remember the current step in a document. If the document is closed and later reopened, the copyholder will initialize to correct step and scroll text on the page if necessary.

While the above is a description of the preferred embodiments of the invention, various alternatives, substitutions and modifications may be made without departing from the scope thereof, which is defined by the following claims. Thus, the preferred embodiments should not be taken as limiting the scope of the invention. Furthermore, the present invention is directed to a number of separate inventions and each of these inventions may be claimed independently of one another. Each feature, aspect and advantage of the invention may be claimed independent of one another without departing from the scope of the invention. Thus, the invention does not include a single essential feature, aspect or advantage and the invention should not be limited as such. It is intended, therefore, that the invention be defined by the scope of the claims which follow and that such claims be interpreted as broadly as is reasonable.

While the invention will be described in conjunction with a procedure management application, it is understood that it is not intended to limit the invention to this one application. To the contrary, it is intended to cover alternatives, modifications and equivalents as may be included within the scope of the invention as defined by the appended claims. It will be apparent to one skilled in the art that the implementation of such a user interface can be achieved in a variety of ways.

1. A user interface for viewing, navigating and using online procedure documents, each procedure document including a set of well defined steps defining a procedure content, the user interface comprising:
a copyholder that is a sliding window, the copyholder surrounding a step in the procedure document, the step enclosed by the copyholder being an active step;, a representation of the copyholder being a line guide that slides across document text and guides a user through the set of steps of the document;
a toolbar on the copyholder, the toolbar including toolbar icons that represent actions to be performed on the active step of the document;
an auto advance feature of the copyholder to advance the copyholder to a subsequent next step in the document;
at least one navigation icon on the copyholder that enables the user to drag and drop the copyholder to any step defined in the document.

2. The user interface of claim 1, wherein the copyholder displays the contents of the active step of the procedure document within a copyholder window.

3. The user interface of claim 2, wherein a width of the copyholder is set to a width of the active display page.

4. The user interface of claim 2, wherein a length of the copyholder is determined by content of the active step in the procedure document, and the copyholder lengthens to enclose an entire content of the active step.

5. The user interface of claim 1, wherein the copyholder is represented as a line guide on a procedure document page.

6. The user interface of claim 1, wherein the copyholder interactively guides the user through each step of the procedure document.

7. The user interface of claim 1 wherein the copyholder window is expanded to include toolbar actions that affect an active step of the procedure document.

8. The user interface of claim 7, wherein the toolbar actions are represented as icons or links on the copyholder.

9. The user interface of claim 7, wherein the toolbar actions represent step specific actions for the procedure document.

10. The user interface of claim 9, wherein the toolbar actions include step completion actions.

11. The user interface of claim 9, wherein the step completion actions are selected from at least one of, marking a procedure step as completed, failed, skipped and stalled.

12. The user interface of claim 10, wherein the copyholder automatically advances to a next step of the procedure document when a step completion action is selected.

13. The user interface of claim 1, wherein the copyholder is movable by the user to any step defined within the procedure document.

14. The user interface of claim 1, wherein the copyholder advances and displays around a first step of a procedure document when opened by the user.

15. The user interface of claim 1, wherein the active step of the procedure document is tracked by an underlying system, wherein the underlying system determines next and or previous points in the procedure document.

16. The user interface of claim 1, wherein the active step of the procedure document is tracked by an underlying system if the procedure is closed.

17. The user interface of claim 1, wherein the active step is initialized by the underlying system if the procedure had been suspended by the user.

18. The user interface of claim 17, wherein the copyholder advances and displays the last worked on step of a procedure when a procedure is resumed.

19. The user interface of claim 1, wherein the copyholder is collapsible and viewable as a clip attached to an edge of the procedure document.

20. The user interface of claim 19, wherein the collapsed copyholder includes action icons that represent step specific actions that can be performed on the active step and navigation icons that enable the user to move the collapsed copyholder within the procedure document

21. The user interface of claim 1, wherein the copyholder has a solid or transparent frame.

22. The user interface of claim 1, wherein the user interface is configured to provide that at least a portion of a user's screen is isolated from a remaining portion of a user's desktop and reserved to display the copyholder to create a copyholder docked view.

23. The user interface of claim 22, wherein the set of steps of the procedure document scroll through a copyholder docked view.

24. The user interface of claim 22, wherein in the copyholder docked view the copyholder is fixed on a screen and text of a step moves.

25. The user interface of claim 22, wherein in a full view the copyholder moves to a next step in the procedure document and the text is fixed on a screen.

26. The user interface of claim 22, wherein the docked view contains action and navigation icons.

27. A user interface for viewing and navigating an online document that includes sections, comprising:
a copyholder that is a sliding window, the copyholder surrounding a section of the document with a section that is surrounded being an active section, a representation of the copyholder being a line guide that slides across text of the online document and guides a user through the sections of the online document, the copyholder including an auto advance that provides advancement to a next section in the document, the copyholder including navigation icons that permit the user to drag and drop the copyholder to any section in the document; and a toolbar on the copyholder with toolbar icons that represent actions to be performed on the active section of the document.

28. The user interface of claim 27, wherein the copyholder displays contents of the active section of the document within the sliding window.

29. The user interface of claim 27, wherein a width of the copyholder is set to a width of the current page displayed

30. The user interface of claim 27, wherein a length of a copyholder will vary depending on a size of the active section of the document.

31. The user interface of claim 27, wherein the copyholder is represented as a line guide that interactively guides the user through each section of the document.

32. The user interface of claim 27, wherein the copyholder is expanded to include toolbar actions that affect the active section of the document.

33. The user interface of claim 32, wherein the toolbar actions are represented as icons or links on the copyholder to an action to be performed on the active section of the document.

34. The user interface of claim 32, wherein the toolbar actions represent actions specific to a document section related to underlying document text.

35. The user interface of claim 32, wherein the copyholder automatically advances to the next section of the document when a section is marked as completed.

36. The user interface of claim 27, wherein the copyholder is movable by the user to any section defined within the document.

37. The user interface of claim 27, wherein the copyholder surrounds a first section of a document when the document is opened by the user.

38. The user interface of claim 27, wherein the active section of the document is tracked by the underlying system and the copyholder is displayed around the active section.

39. The user interface of claim 27, wherein the copyholder is collapsible and viewable as a clip attached to an edge of the document.

40. The user interface of claim 39, wherein the collapsed copyholder includes action icons that represent section specific actions to be performed on the active section and navigation icons that enable the user to move the collapsed copyholder within the document.

41. A method of navigating and using online procedure documents that include a set of well defined steps defining procedure content of a procedure document, comprising:
using a copyholder that is a sliding window to surround a step in the procedure document, wherein the step enclosed by the copyholder is an active step;
using a representation of the copyholder as a line guide to slide across text of the procedure document and guide a user through the set of steps of the procedure document;
utilizing a toolbar on the copyholder that includes toolbar icons representing actions to be performed on the active step of the procedure document;
advancing the copyholder to a subsequent next step in the procedure document; and
using at least one navigation icon on the copyholder to drag and drop the copyholder to any step defined in the procedure document.

42. The method of claim 41, wherein text displayed within the copyholder is active text and actions are only performed on the active text.

43. The method of claim 41, wherein sections of the procedure document are determined by an underlying system, wherein the underlying system determines next and or previous points in the procedure document.

44. The method of claim 43, wherein a section is a step in the procedure document or a paragraph of text in the procedure document.

45. The method of claim 41, wherein an initial location of the copyholder on a procedure document page will be determined by the position of the first step or section of the procedure document.

46. The method of claim 41, wherein an underlying system records a last marked step or section of the procedure document on exit.

47. The method of claim 46, wherein the underlying system calculates a next active step or section of the procedure document and advances the copyholder to this location when the procedure document is reopened.

48. The method of claim 41, wherein text of the procedure document scrolls to a correct location to display a current content of the copyholder.

49. The method of claim 47, wherein the next step or section within the procedure document is determined by the underlying system.

50. The method of claim 47, wherein a length of the copyholder is calculated by the underlying system.

51. The method of claim 47, wherein the underlying system implements actions available on the toolbar.
